(19) United States
(12) Patent Application Publication
(10) Pub. No.: US 2005/0284581 A1
(43) Pub. Date: Dec. 29, 2005

(54) Device for preventing the adhesive tape of an adhesive-tape cutter from rewinding

(76) Inventor: Hsiu-Man Yu Chen, Taichung (TW)

Correspondence Address: TROXELL LAW OFFICE PLLC, SUITE 1404, 5205 LEESBURG PIKE, FALLS CHURCH, VA, 22041, US

(21) Appl. No.: 10/873,179

(22) Filed: Jun. 23, 2004

(51) Int. Cl. B29C 65/50; B29C 65/00

(52) U.S. Cl. 156/523; 156/527

(57) ABSTRACT

A device for preventing the adhesive tape of an adhesive-tape cutter from rewinding includes at least one engage stud with an engage groove provided at a preset side near the front end of a main body. An elastic compressing plate has one end engaged with the engage stud and the other end extending forward obliquely to elastically compress the upper circumferential surface of a roller. When an adhesive tape is inserted through between the roller and a guiding-and-conveying roller, it will be exactly compressed by the elastic compressing plate. Thus, the adhesive tape is only able to be drawn forward but impossible to retreat, able to prevent the adhesive tape from rewinding. The device is simple in structure and able to lower producing and assembling cost.

### BACKGROUND OF THE INVENTION

1. Field of the Invention

This invention relates to a device for preventing the adhesive tape of an adhesive-tape cutter from rewinding, particularly to one simple in structure and able to lower producing and assembling cost.

2. Description of the Prior Art

Generally, when a conventional adhesive-tape cutter begins pasting work, the front end of the adhesive tape of an adhesive-tape roll has to be drawn outward for a certain distance before carrying out subsequent pasting. However, the conventional adhesive-tape cutter is provided with no device for preventing the adhesive tape from rewinding; therefore, the adhesive-tape roll is likely to rotate backward and the front end of the adhesive tape may shrink inward and even adhere to the adhesive-tape roll when the adhesive tape is released or retreated, resulting much trouble and inconvenience to subsequent pasting work.

### SUMMARY OF THE INVENTION

The objective of the invention is to offer a device for preventing the adhesive tape of an adhesive-tape cutter from rewinding, provided with at least one engage stud with an engage groove positioned at a preset side near the front end of the main body of an adhesive-tape cutter, and an elastic compressing plate having one end engaged with the engage groove of the engage stud and the other end extending forward obliquely to elastically compress the upper circumferential surface of the roller of the adhesive-tape cutter. Thus, when the adhesive tape of an adhesive-tape roll is inserted through between the roller and a guiding-and-conveying roller, it will be properly compressed by the elastic compressing plate.

By so designing, the adhesive tape elastically compressed by the elastic compressing plate can only be drawn forward, but cannot retreat. The invention is simple in structure and able to lower producing and assembling cost, having great practicability.

### BRIEF DESCRIPTION OF DRAWINGS

This invention will be better understood by referring to the accompanying drawings, wherein:

FIG. 1 is a perspective view of a first preferred embodiment of an adhesive-tape cutter in the present invention:

FIG. 2 is a side view of the first preferred embodiment of the adhesive-tape cutter in the present invention:

FIG. 3 is a side cross-sectional view of the first preferred embodiment of the adhesive-tape cutter in the present invention:

FIG. 4 is a partial magnified side cross-sectional view of the first preferred embodiment of the adhesive-tape cutter in the present invention:

FIG. 5 is a perspective view of a second preferred embodiment of an adhesive-tape cutter in the present invention:

FIG. 6 is a perspective view of a third preferred embodiment of an adhesive-tape cutter in the present invention: and

FIG. 7 is a perspective view of a fourth preferred embodiment of an adhesive-tape cutter in the present invention.

### DETAILED DESCRIPTION OF THE PREFERRED EMBODIMENT

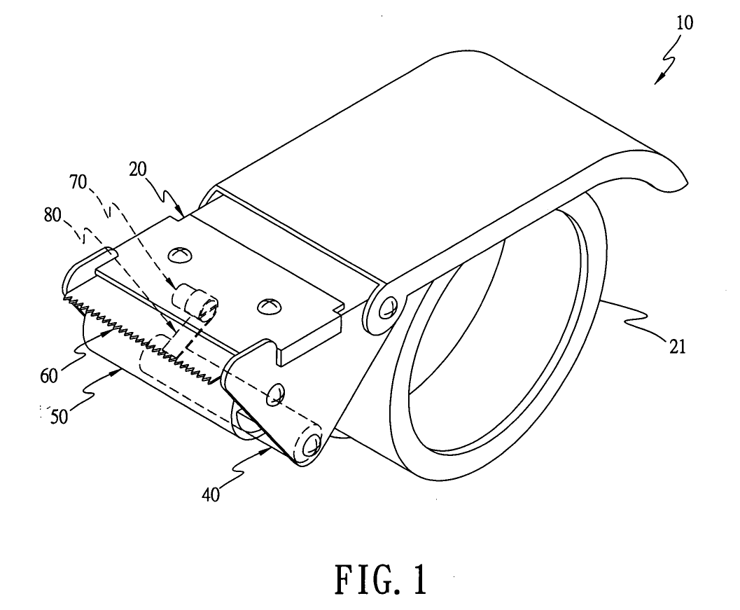

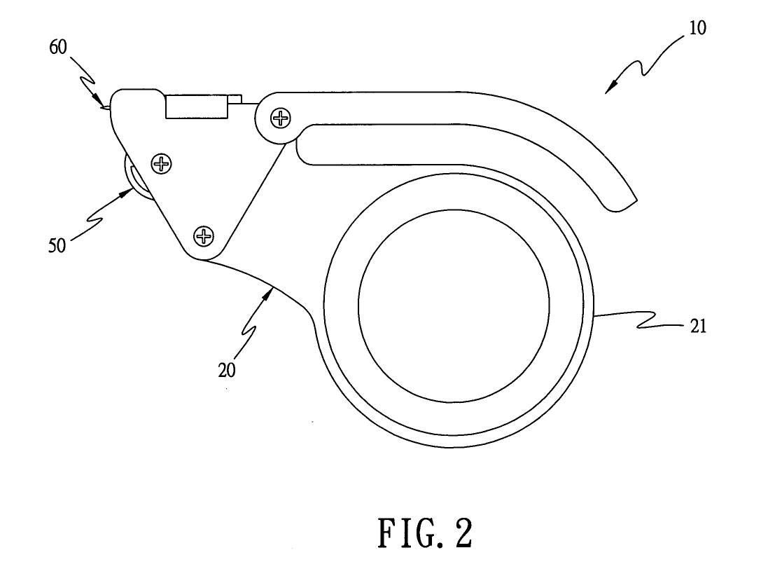

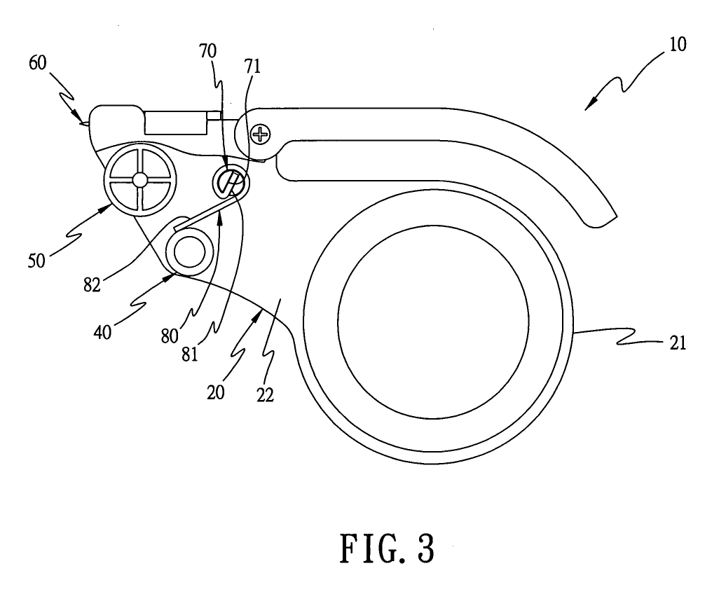

A first preferred embodiment of a device for preventing the adhesive tape of an adhesive-tape cutter from rewinding in the present invention, as shown in FIGS. 1, 2 and 3, includes a handy adhesive-tape cutter 10, a main body 20, an adhesive-tape roll 30, a roller 40, a guiding-and-conveying roller 50, a blade 60, an engage stud 70 and an elastic compressing plate 80 combined together.

The main body 20 is provided with a pivotal shaft 21 for fitting and positioning the adhesive-tape roll 30. The roller 40, the guiding-and-conveying roller 50 and the blade 60 are provided at the front end of the main body 20. The adhesive tape of the adhesive-tape roll 30 is inserted through between the roller 40 and the guiding-and-conveying roller 50 to be wound around the circumferential surface of the guiding-and-conveying roller 50 and then moved to the location of the blade 60 for carrying out pasting.

The engage stud 70 is fixed at a preset side near the front end of the main body 20, having its topside bored with an engage groove 71.

The elastic compressing plate 80 is made of a flexible steel plate rolled properly. The elastic compressing plate 80 is formed with an engage end 81 to be engaged with the engage groove 71 of the engage stud 70 and a compressing end 82 extending forward obliquely to elastically compress the upper circumferential surface of the roller 40. Thus, when the adhesive tape 31 of the adhesive-tape roll 30 passes through between the roller 40 and the guiding-and-conveying roller 50, it will be timely compressed by the compressing end 82 of the elastic compressing plate 80, only able to be drawn forward but impossible to retreat.

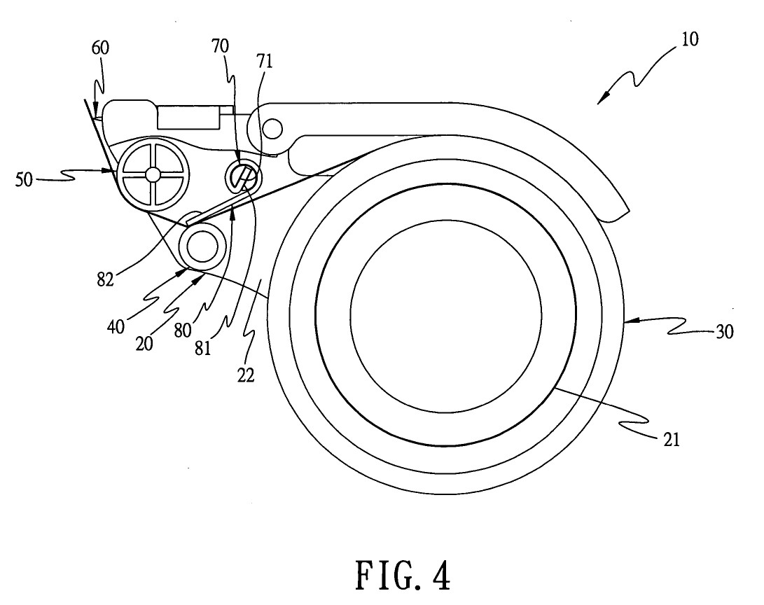

In using, as shown in FIG. 4, firstly, the adhesive-tape roll 30 is pivotally fitted on the pivotal shaft 21 of the main body 20 and the adhesive tape 31 fitted thereon is drawn forward. Next, the flexible compressing end 82 of the elastic compressing plate 80 is pulled upward to separate from the upper circumferential surface of the roller 40 so as to enable the adhesive tape 31 to pass through the gap between the compressing end 82 and the roller 40. Lastly, the adhesive tape 31 is wound around the circumferential surface of the guiding-and-conveying roller 50 and then drawn to the location of the blade 60 to begin to stick adhesive tape. When the compressing end 82 of the elastic compressing plate 80 contacts with the roller 40, there will produce a resistance to stop the roller 40 from rotating backward; therefore, the adhesive tape 31 compressed by both the compressing end 82 of the elastic compressing plate 80 and the upper circumferential surface of the roller 40 can be drawn forward only, but cannot retreat, thus preventing the adhesive tape from rewinding and enabling it to be drawn forward smoothly.

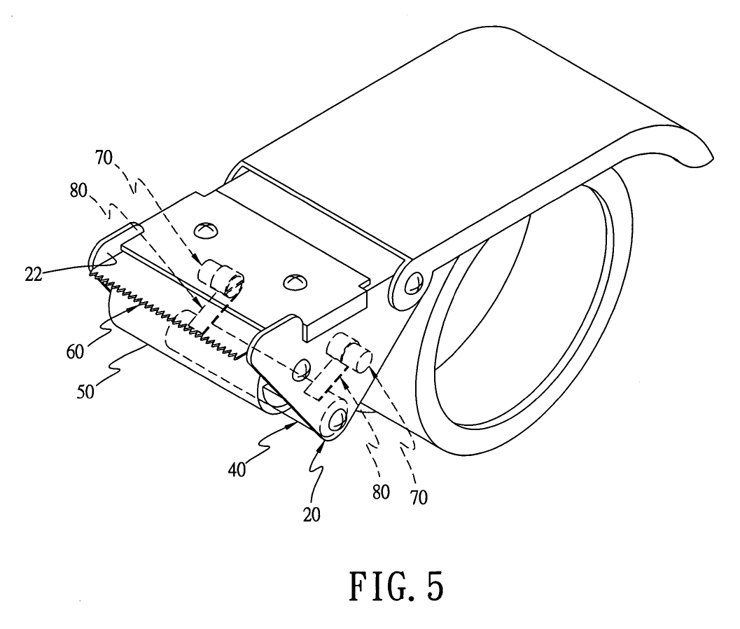

A second preferred embodiment of a device for preventing the adhesive tape of an adhesive-tape cutter from rewinding in the present invention, as shown in FIG. 5, is to have two symmetrical engage studs 70 respectively provided at the opposite sides 22 near the front end of the main body 20 and two elastic compressing plates 80 respectively engaged with the two engage studs 70 to elastically compress the left and the right upper circumferential surface of a roller 40, letting the adhesive tape 31 compressed by the two elastic compressing plates 80 in a balanced condition to avoid rewinding.

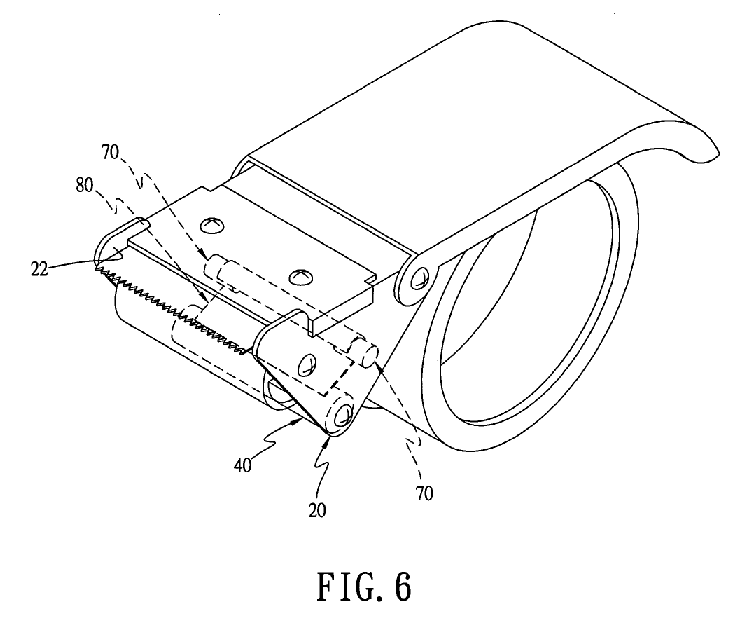

A third preferred embodiment of a device for preventing the adhesive tape of an adhesive-tape cutter from rewinding in the present invention, as shown in FIG. 6, is to have two symmetrical engage studs 70 respectively provided at the opposite sides 22 near the front end of the main body 20 and a transverse elongate elastic compressing plate 80 provided between the two engage studs 70 to elastically compress the substantial portion of the upper circumferential surface of a roller 40 and the adhesive tape 31 positioned thereon, having an excellent effect of preventing the adhesive tape 31 from rewinding.

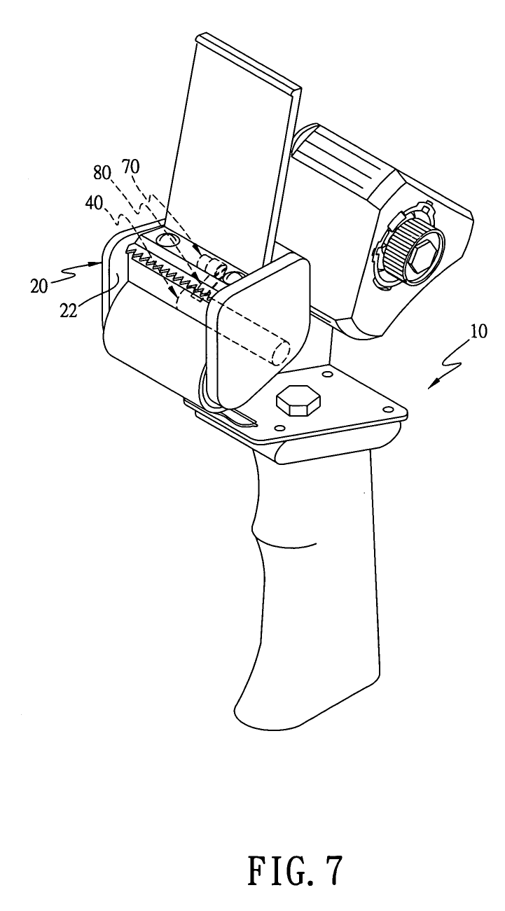

A fourth preferred embodiment of a device for preventing the adhesive tape of an adhesive-tape cutter from rewinding in the present invention, as shown in FIG. 7, is to have an engage stud 70 provided at a preset side 22 of the main body 20 of a hand-held adhesive-tape cutter 10 and an elastic compressing plate 80 having one end engaged with the engage stud 70 and the other end compressing the upper circumferential surface of a roller 40 and the adhesive tape positioned thereon, able to prevent the adhesive tape from rewinding.

Evidently, this invention has the following advantages.

1. The adhesive-tape cutter 20 of this invention is provided with the elastic compressing plate 80 to elastically compress the upper circumferential surface of the roller 40 to restrict the roller 40 to rotate forward only, able to prevent the adhesive tape 31 from rewinding.

2. It needs only one engage stud 70 and one elastic compressing plate 80 provided at a preset side of an adhesive-tape cutter 20 to prevent an adhesive tape from rewinding, simple in structure, easy and quick in assembly, lower in cost and conforming to economical gain.

While the preferred embodiments of the invention have been described above, it will be recognized and understood that various modifications may be made therein and the appended claims are intended to cover all such modifications that may fall within the spirit and scope of the invention.

1-5. (canceled)

6. A device for preventing an adhesive tape of an adhesive tape roll from rewinding on an adhesive tape cutter, the device comprising:
a) a main body having a pivotal shaft inserted into the adhesive tape roll;
b) a roller located on a front end of the main body;
c) a blade located on a front end of the main body;
d) a guiding and conveying roller located on a front end of the main body between the roller and the blade;
e) at least one engage stud located on a side of the main body and having an engage groove; and
f) at least one elastic compressing plate having an engage end and a compressing end, the engage end being inserted into the engage groove and wound around an outer periphery of the at least one engage stud, the compressing end elastically pressing against the exterior surface of the roller,
wherein, when the adhesive tape is inserted between the roller and the at least one elastic compressing plate, wound around an outer surface of the guiding and conveying roller toward the blade, the at least one elastic compressing plate engaging the adhesive to prevent the adhesive tape from rewinding on the roller.

7. The device according to claim 6, wherein the at least one engage stud includes two symmetrical engage studs located on opposing sides of the main body, the at least one elastic compressing plate including two elastic compressing plates, each of the two elastic compressing plates is connected to one of the two symmetrical engage studs.

8. The device according to claim 6, wherein the at least one engage stud includes two symmetrical engage studs located on opposing sides of the main body, the at least one elastic compressing plate is connected to both of the two symmetrical engage studs.

9. The device according to claim 6, wherein the engage groove of the at least one engage stud is formed by cutting a topside of the engage stud.

10. The device according to claim 6, wherein the at least one elastic compressing plate is a steel plate having a predetermined flexibility.
